(19) United States
(12) Patent Application Publication
(10) Pub. No.: US 2010/0030707 A1
(43) Pub. Date: Feb. 4, 2010

(54) IMAGE FORMING APPARATUS AND IMAGE FORMING METHOD

(75) Inventor: Hidehito JINGU, Tokyo (JP)

Correspondence Address: MOTS LAW, PLLC, 1629 K STREET N.W., SUITE 602, WASHINGTON, DC, 20006-1635, US

(73) Assignee: Oki Data Corporation

(21) Appl. No.: 12/490,886

(22) Filed: Jun. 24, 2009

(30) Foreign Application Priority Data
Jul. 29, 2008 (JP) JP2008-194517

(51) Int. Cl. G06F 17/00; G06F 21/20; G06F 3/12

(52) U.S. Cl. 705/400; 726/4; 358/1.15

(57) ABSTRACT

An image forming apparatus includes: a web server configured to prompt a user to specify a file as a printing target by an external apparatus and to input information of the user by the external apparatus; an authentication unit configured to authenticate the user based on the input information input by the external apparatus; a transmission/reception unit configured to transmit permission or denial to transmit data from the external apparatus based on an authentication result of the authentication unit; and a print data converter configured to convert the data received from the external apparatus into a printable format.

### CROSS REFERENCE TO RELATED APPLICATIONS

This application claims priority based on 35 USC 119 from prior Japanese Patent Application No. P2008-194517 filed on Jul. 29, 2008, entitled “Image Forming Apparatus and Image Forming Method”, the entire contents of which are incorporated herein by reference.

### BACKGROUND OF THE INVENTION

1. Field of the Invention

The invention relates to an image forming apparatus and an image forming method.

2. Description of Related Art

As a printing method using an image forming apparatus, a method called direct print has been known heretofore. In the direct print mode, an image forming apparatus receives directly, from an host apparatus such as a personal computer or a mobile terminal, a file created using application software installed on the host apparatus and then prints the file (for example, Japanese Patent Application Publication 2002-351637).

With this printing mode, printing is accomplished by transmitting application data created by the application software in the host apparatus directly from the host apparatus to the image forming apparatus without using a printer driver. Accordingly, printing can be accomplished by an host apparatus on which a printer driver cannot be installed because the host apparatus includes deficient units such as a computing unit having low processing performance or a storage unit having a small storage capacity. In addition, this method eliminates time and effort required for installing the printer driver on the host apparatus.

Examples of methods for transmitting application data to an image forming apparatus from an host apparatus, there are the following. In one of the methods, a file to be printed is selected from a web page of an image forming apparatus, and the file is then transmitted to the image forming apparatus. In another method, a file to be printed is attached to an e-mail, and then the e-mail is sent with the attached file to an image forming apparatus.

However, in a conventional image forming apparatus, charging a printing fee based on the number of the printed pages, and/or setting a printing limitation on the number of printable pages for each user cannot, for example, be implemented in a direct print mode. In recent years, many image forming apparatus connected to networks, such as a network printer, have included the capability to limit the number of printable pages of color printing for each user, or to charge a printing fee based on the number of the printed pages. However, direct print is a convenience-oriented printing method, and does not identify users. For this reason, direct print does not allow the conventional image forming apparatus to charge a printing fee based on the number of printed pages for each user or to limit the number of printable pages for each user. This is because, an existing printing method using a printer driver adds authentication information to print data, whereas authentication information is not available in the direct print mode not using a printer driver.

Moreover, there is no limitation on access to a web page of an image forming apparatus except that a specific operation is limited to only an administrator of the image forming apparatus. In addition, in the case where an host apparatus mainly performing a direct print is a mobile terminal, it is difficult to provide a graphical user interface (GUI) for inputting authentication information due to limitations of the size of the keyboard and the size of the display.

For this reason, when an image forming apparatus supporting a direct print mode is used in environment where charge processing or printing limitation is required, the direct print function must be disabled.

### SUMMARY OF THE INVENTION

An aspect of the present invention is an image forming apparatus including: a web server configured to prompt a user to specify a file as a printing target by an external apparatus and to input information of the user by the external apparatus; an authentication unit configured to authenticate the user based on the input information input by the external apparatus; a transmission/reception unit configured to transmit permission or denial to transmit data from the external apparatus based on an authentication result of the authentication unit; and a print data converter configured to convert the data received from the external apparatus into a printable format.

### BRIEF DESCRIPTION OF THE DRAWING

FIG. 1 is a diagram showing a system of a printer in a first embodiment.

FIG. 2 is a diagram showing a data structure of an authority information database in the first embodiment.

FIG. 3 is a diagram showing a data structure of a charge log storage unit in the first embodiment.

FIG. 4 is a diagram showing a communication procedure between the printer and a PC in the first embodiment.

FIG. 5 is a diagram showing an example of a top page in the first embodiment.

FIG. 6 is a diagram showing an example of a direct print execution page in the first embodiment.

FIG. 7 is a diagram showing an example of an authentication information input dialog in the first embodiment.

FIG. 8 is a diagram showing an example of an authentication failure notification page in the first embodiment.

FIG. 9 is a diagram showing an example of printing start notification page in the first embodiment.

FIG. 10 is a diagram showing an example of printing result notification page in the first embodiment.

FIG. 11 is a flowchart showing an operation of the printer in the first embodiment.

FIG. 12 is a flowchart showing a subroutine of authentication processing in the first embodiment.

FIG. 13 is a diagram showing a system of a printer in a second embodiment.

FIG. 14 is a diagram showing a communication procedure between the printer and a PC in the second embodiment.

FIG. 15 is a diagram showing an example of a web page for specifying printing attributes in the second embodiment.

FIG. 16 is a diagram showing an example of a printing attribute change notification page in the second embodiment.

FIG. 17 is a flowchart showing an operation of the printer in the second embodiment.

FIG. 18 is a flowchart showing a subroutine of authentication processing in the second embodiment.

FIG. 19 is a flowchart showing a subroutine of printing attribute determination processing in the second embodiment.

### DETAILED DESCRIPTION OF EMBODIMENTS

Descriptions are provided hereinbelow for embodiments based on the drawings. In the respective drawings referenced herein, the same constituents are designated by the same reference numerals and duplicate explanation concerning the same constituents is basically omitted. All of the drawings are provided to illustrate the respective examples only. No dimensional proportions in the drawings shall impose a restriction on the embodiments. For this reason, specific dimensions and the like should be interpreted with the following descriptions taken into consideration. In addition, the drawings include parts whose dimensional relationship and ratios are different from one drawing to another.

Hereinafter, embodiments of the invention are described in detail with reference to the drawings.

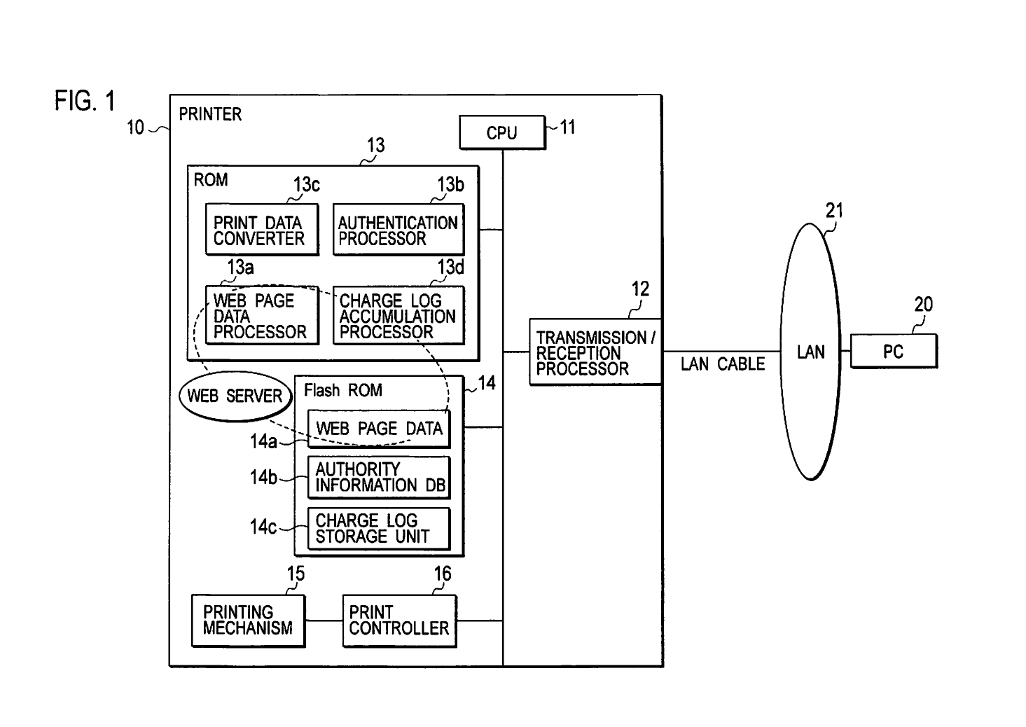

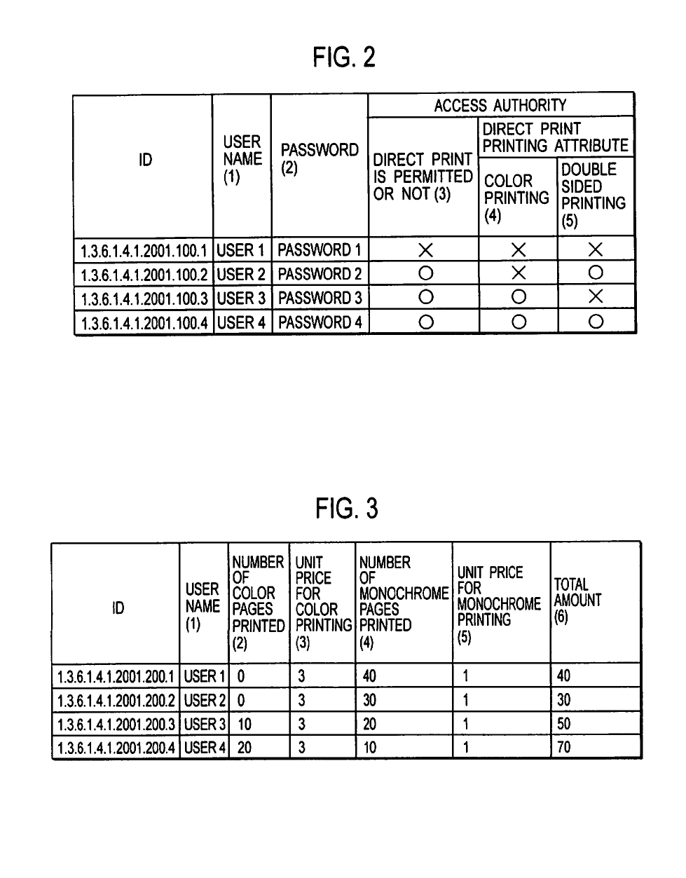

FIG. 1 is a diagram showing a system of a printer in a first embodiment. FIG. 2 is a diagram showing a data structure of an authority information database in the first embodiment. FIG. 3 is a diagram showing a data structure of a charge log storage unit in the first embodiment.

In FIG. 1, an image forming apparatus in this embodiment is printer 10. Note that, the image forming apparatus in this embodiment may be any apparatus as long as it is capable of communicating with a computer and printing print data received from the computer on a recording medium such as a recording paper. For example, a facsimile apparatus or a multi function printer (MFP) may be employed as the image forming apparatus, the multi function printer provided with a combination of functions of an image reading apparatus (scanner), a printer, a facsimile apparatus, a copier and the like. Here, a description is given of a case where the image forming apparatus is a printer.

Furthermore, a method of printing print data on a recording medium by printer 10 may be of any type such as an inkjet method, an electrophotographic method or a thermal transfer method, and the method may be for forming a monochrome image or a color image.

Printer 10 is connected to, and communicates with personal computer (PC) 20 via network 21, PC 20 being the host apparatus serving as an external apparatus which transmits print data. Note that, the host apparatus in this embodiment may be any apparatus as long as it is capable of creating print data, serving as application data, by use of application software installed on the host apparatus and of transmitting the print data. For example, the host apparatus may be a server, a mobile phone, a personal digital assistant (PDA), a game console, a mobile terminal or the like. Here, the description is given of a case where the host apparatus is a PC.

Network 21 is a dedicated communication line network such as a LAN or a wide area network (WAN) consisting of dedicated communication lines or the like. However, any kind of network may be employed as long as it is capable of communicating print data. Here, network 21 is a LAN. Note that, printer 10 and PC 20 are connected to network 21 via LAN cables.

Printer 10 includes: CPU 11; transmission/reception processor 12 as a transmission/reception unit; ROM 13 as a storage unit for storing a control program and the like therein; Flash ROM 14 as a storage unit for storing web page data and the like therein; printing mechanism 15 as a printing unit including a paper feed mechanism, a printing head and the like for printing data on a recording medium; and print controller 16 configured to control printing mechanism 15.

CPU 11 is a controller including a computing unit and has overall control over operations of the components of printer 10. Transmission/reception processor 12 includes a communication interface for performing communications via network 21 and the like, and transmits and receives data to and from PC 20.

ROM 13 includes web page data processor 13a, authentication processor 13b, print data converter 13c and charge log accumulation processor 13d. Web page data processor 13a transmits web page data to PC 20 in response to a request from PC 20. Authentication processor 13b compares authentication information received from PC 20 with authority information stored in authority information database (DB) 14b of printer 10 as previously registered authority information and thereby determines whether or not to allow a direct print. Print data converter 13c converts a file (print data) received from PC 20 into a printable format. Charge log accumulation processor 13d updates charge log storage unit 14c in response to an accepted direct print request.

Flash ROM 14 includes: web page data 14a to be transmitted to PC 20; authority information database 14b serving as an authority information storage unit which stores authority information of each user for accessing printer 10; and charge log storage unit 14c which stores the number of executed direct prints and a printing fee for each user.

Note that, printing mechanism 15 is provided with the paper feed mechanism, a printing head and the like and prints data such as print data on a recording medium such as a recording paper. Moreover, print controller 16 controls an operation of printing mechanism 15.

When PC 20 transmits print data to printer 10, transmission/reception processor 12 of printer 10 receives the print data.

CPU 11, web page data processor 13a and web page data 14a accomplish a web server function performed by printer 10 in this embodiment. In other words, CPU 11, web page data processor 13a and web page data 14a function as a web server. In response to a web access request from PC 20, CPU 11 causes web page data processor 13a to operate. Then, web page data processor 13a transmits web page data read from web page data 14a to PC 20 through transmission/reception processor 12. A web page, which is to be displayed by a display of PC 20 on the basis of the web page data, functions as a specifying unit for allowing a user to specify a text or an image file as a print target and also functions as an input unit for allowing a user to input user authentication information. In addition, authentication processor 13b functions as an authentication unit, and charge log accumulation processor 13d functions as a charge unit.

FIG. 2 shows an example of authority information registered in authority information database 14b. In the example shown in FIG. 2, authority information database 14b stores authentication information of each user such as a user name and a password, and authority information of each user such as permissions for direct printing, monochrome printing, color printing, etc.

For example, for the user with user name “User1,” the password “Password1” is required information for authentication, but this user is not authorized to execute a direct print. Meanwhile, for the user with user name “User2,” the password “Password2” is required information for authentication, and this user is authorized to execute a direct print.

In this embodiment, since information registered in authority information database 14b is defined as management information base (MIB) information, the information can be edited by a general simple network management protocol (SNMP) tool or the like. The information is also assumed to be edited from an unillustrated operation panel of printer 10 or a web browser. Note that a known technology is used as editing means for the information registered in authority information database 14b, and therefore a description of the editing means is omitted herein. In this embodiment, the information is previously registered in authority information database 14b.

In addition, FIG. 3 shows an example of the information registered in charge log storage unit 14c. In the example shown in FIG. 3, charge log storage unit 14c stores, for each user, a user name, the number of pages printed in color, a unit price for color printing, the number of pages printed in monochrome, a unit price for monochrome printing and the total printing fee.

For example, for the user with the user name “User3,” the number of pages printed in color is ‘10’ for the unit price for color printing, ‘3,’ and the number of pages printed in monochrome is ‘20’ for the unit price for monochrome print, ‘1.’ Accordingly, the total printing fee is ‘50.’

In this embodiment, the information registered in charge log storage unit 14c is defined as MIB information, and therefore the information can be referenced by use of a general SNMP tool or the like. In addition, the information is assumed to be referenced through an operation panel of printer 10 or a web browser. Moreover, a unit price is assumed to be changeable by the aforementioned editing means. In this embodiment, the information except the numbers of printed pages and the total printing fee are assumed to be previously registered in charge log storage unit 14c.

Next, a communication procedure between printer 10 and PC 20 is described.

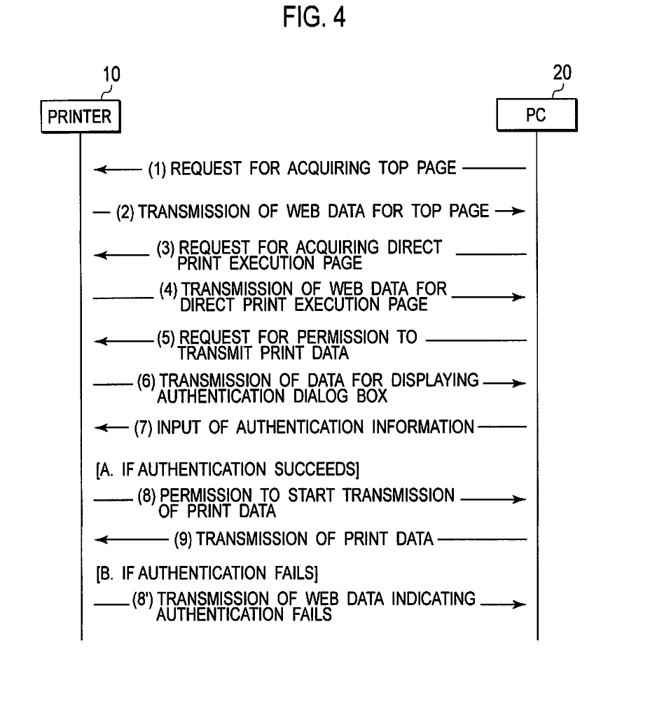

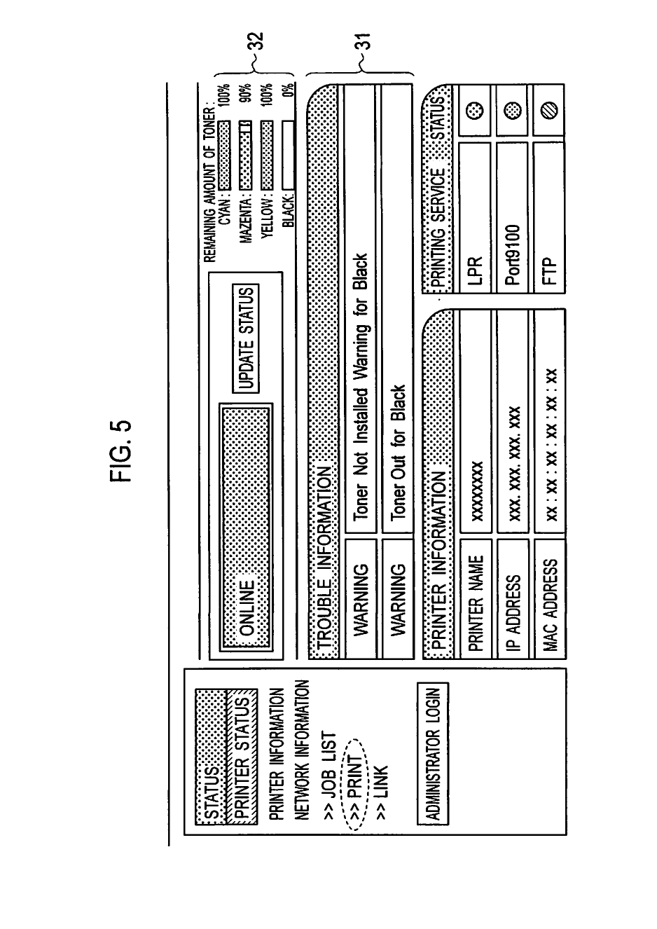

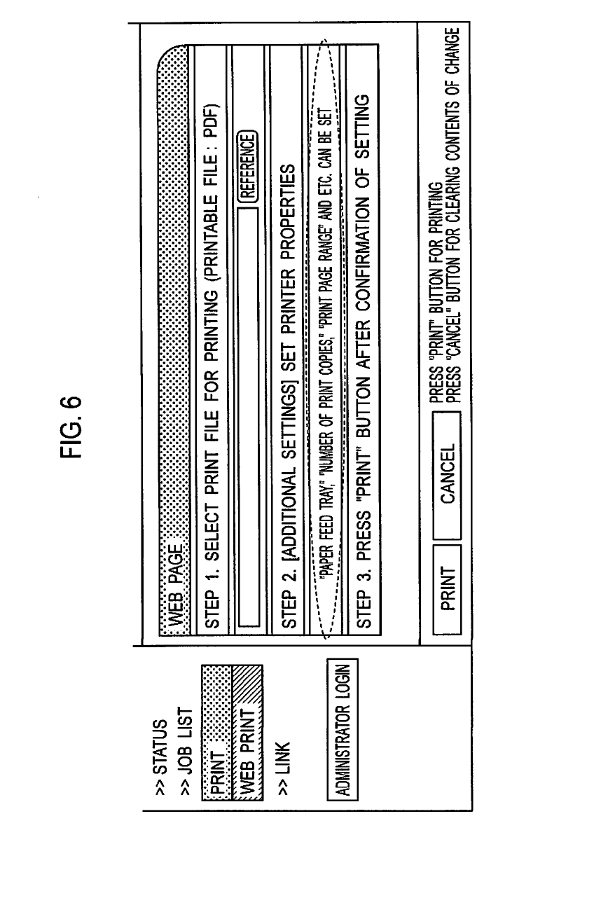

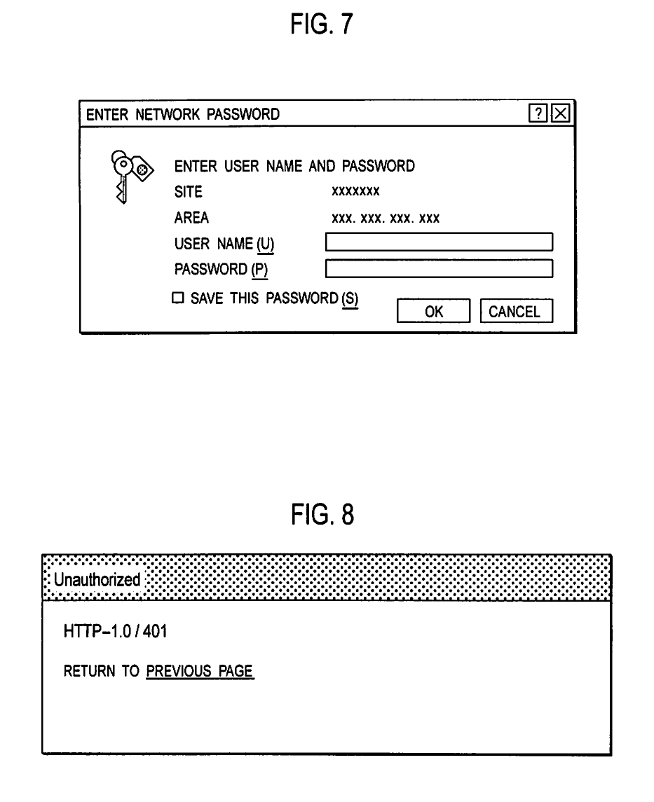

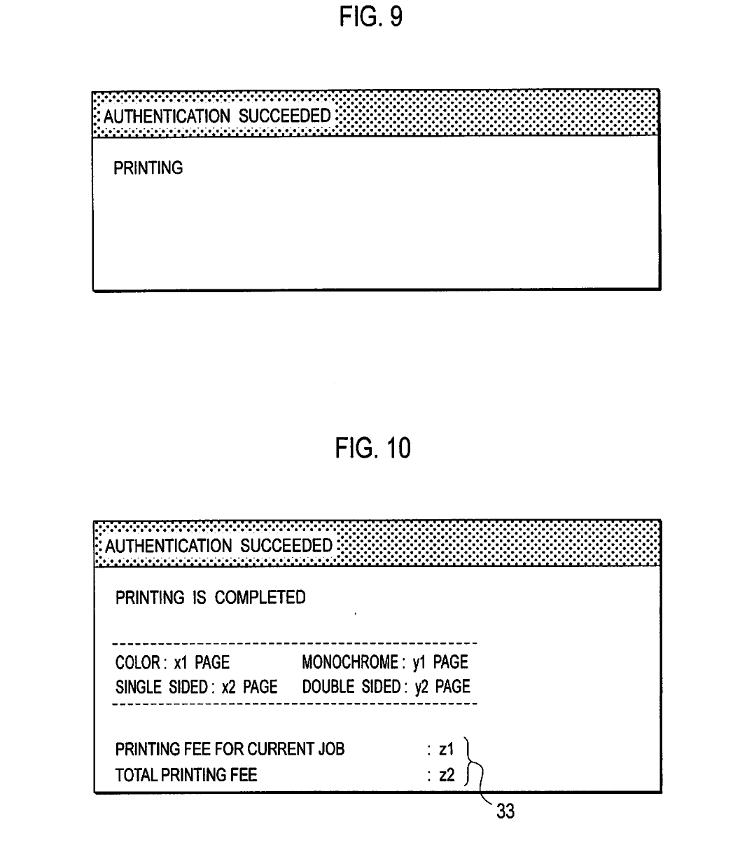

FIG. 4 is a diagram showing the communication procedure between the printer and the PC in the first embodiment; FIG. 5 is a diagram showing an example of a top page in the first embodiment; FIG. 6 is a diagram showing an example of a direct print execution page in the first embodiment; FIG. 7 is a diagram showing an example of an authentication information input dialog in the first embodiment; FIG. 8 is a diagram showing an example of an authentication failure notification page in the first embodiment; FIG. 9 is a diagram showing an example of a print start notification page in the first embodiment; and FIG. 10 is diagram showing an example of a print result notification page in the first embodiment.

First, a user operates PC 20 to start a web browser. Upon connecting to an IP address of printer 10 (FIG. 4 (1)), web page data appropriate to the top page is transmitted from printer 10 to PC 20 (FIG. 4 (2)). Then, the top page as shown in FIG. 5 is displayed on the display of PC 20. In the example illustrated in FIG. 5, “Print” shown at the center left portion of the top page is the link for a direct print execution page.

Note that, FIG. 5 also shows trouble information 31, and toner remaining amount information 32. In the example illustrated in FIG. 5, a warning indicating that the remaining amount of toner for black ink is zero is displayed as trouble information 31. Moreover, the remaining amount of toner for each color is displayed as toner remaining amount information 32.

Next, when a user clicks the link for a direct print execution page on the top page displayed on the display of PC 20 (FIG. 4 (3)), web page data of the direct print execution page is transmitted from printer 10 to PC 20 (FIG. 4 (4)). Then, the direct print execution page as shown in FIG. 6 is displayed on the display of PC 20.

When the user selects a file desired to be printed on the direct print execution page displayed on the display of PC 20 and clicks “Print” button at a lower part of the page (FIG. 4 (5)), data required for displaying an authentication information input dialog is transmitted from printer 10 to PC 20 (FIG. 4 (6)). Then, the authentication information input dialog as shown in FIG. 7 is displayed on the display of PC 20.

Subsequently, when the user inputs the user name and the password on the authentication information input dialog displayed on the display of PC 20 and clicks the “OK” button at the lower portion of the dialog, the inputted authentication information is transmitted from PC 20 to printer 10 (FIG. 4 (7)). The authentication information is received by transmission/reception processor 12 of printer 10, and then compared by authentication processor 13b with the authority information stored in authority information database 14b.

When the inputted authentication information is “Not registered” in authority information database 14b, or is “Registered” but “Unauthorized for direct print,” printer 10 transmits to PC 20 a response indicating an authentication failure, and web page data for informing the person attempting to execute a direct print, that is, the user, of the authentication failure (FIG. 4 (8′)). Then, a web page as shown in FIG. 8 is displayed on the display of PC 20, which indicates that the direct print is not executed due to an authentication failure.

In the example of authority information shown in FIG. 2, the following cases fall under “Not registered.” The cases are where any name other than “User1,” “User2,” “User3,” “User4” and “User5” is input as a user name, or where a password not corresponding to a user name is input, such as a case where “User2” is input as the user name, but a password other than “Password2” is input. In addition, when the user name, “User1”, which is not authorized to execute a direct print, and the password, “Password1” are input, the user falls under “Unauthorized for direct print” even though the user is “Registered.”

When the inputted authentication information is “Authorized for direct print,” a response informing permission to start print data transmission is transmitted from printer 10 to PC 20 (FIG. 4 (8)). In response to this, PC 20 transmits a printing target file to printer 10 (FIG. 4 (9)).

In the example of authority information shown in FIG. 2, the case where the user name, “User3” and the password, “Password3” are input falls under “Authorized for direct print.” In this case, the screen shown in FIG. 9 is displayed on the display of PC 20.

Then, print data converter 13c of printer 10 converts the received file into a printable format and print controller 16 controls printing mechanism 15 to execute printing. Note that, a known technique is used for converting the file, and therefore a description thereof is omitted herein.

Upon completion of the printing, charge log accumulation processor 13d of printer 10 updates the number of pages printed in color, the number of pages printed in monochrome and the total printing fee for the user executing the direct print, which are stored in charge log storage unit 14c. Then, an execution result screen shown in FIG. 10 is displayed on the display of PC 20.

Note that, FIG. 10 also shows charge result 33 for the user. Charge result 33 is calculated on the basis of information registered in charge log storage unit 14c shown in FIG. 3 and includes the printing fee for the current jog and the total printing fee.

Next, an operation of printer 10 of the aforementioned configuration is described.

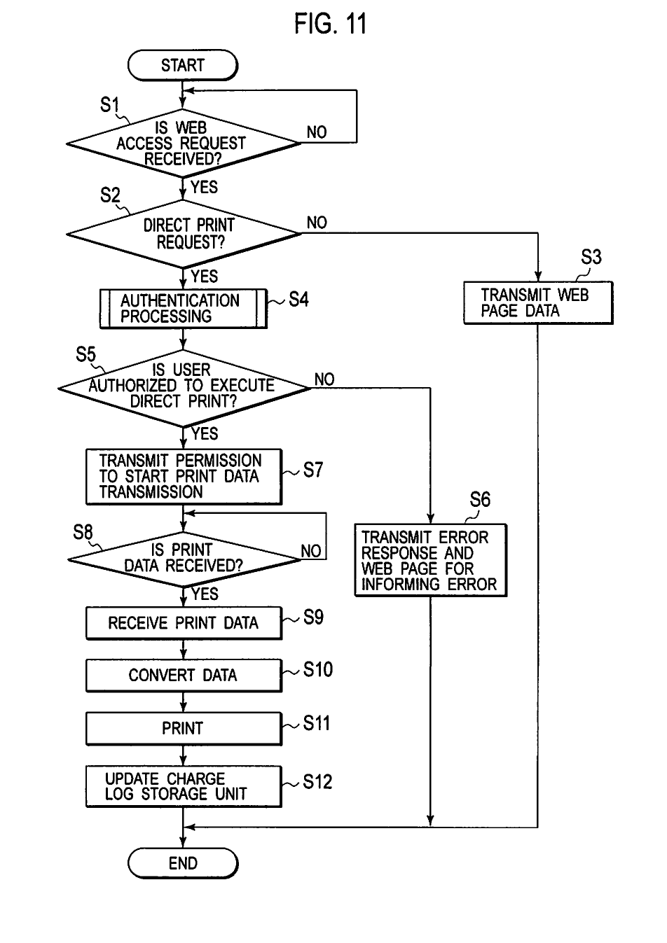

FIG. 11 is a flowchart showing an operation of printer 10 in the first embodiment.

First, transmission/reception processor 12 of printer 10 checks for any new web access request from PC 20. If no request is received, transmission/reception processor 12 repeats checking until receiving a request.

When transmission/reception processor 12 receives a web access request, web page data processor 13a analyzes the received web access request and determines if the web access request is a request for a direct print or a request for web page data. If the request is for web page data, transmission/reception processor 12 transmits web page data read from web page data 14a to PC 20 and ends the processing.

If the request is for a direct print, authentication processor 13b performs authentication processing. Then, authentication processor 13b determines whether or not the user is authorized for the direct print on the basis of the result of the authentication processing. When authentication processor 13b determines that the user is not authorized for the direct print, transmission/reception processor 12 transmits a response of an authentication failure and an authentication failure notification web page read from web page data 14a to PC 12 and ends the processing.

On the other hand, when authentication processor 13b determines that the user is authorized for the direct print, transmission/reception processor 12 transmits print permission (permission to start print data transmission) to PC 20. Subsequently, transmission/reception processor 12 checks for receiving any print data from PC 20. If no print data is received, transmission/reception processor 12 repeats checking until receiving any print data.

When transmission/reception processor 12 receives print data, print data converter 13c converts the received print data into a printable format. Subsequently, print controller 16 prints the converted data onto a recording medium by controlling printing mechanism 15.

Then, charge log accumulation processor 13d updates the number of pages printed in color, the number of pages printed in monochrome and the total printing fee which are stored in charge log storage unit 14c in accordance with the result of the printing and ends the processing.

Next, a description is given of a flowchart of FIG. 11.
Step S1: Transmission/reception processor 12 checks for receiving any web access request from PC 20. If a web access request is received, the processing proceeds to step S2, and if no web access request is received, transmission/reception processor 12 repeats checking until receiving any web access request.
Step S2: Web page data processor 13a determines if the received web access request is a request for a direct print or for web page data. If the request is for a direct print, the processing proceeds to step S4. If the request is for web page data, the processing proceeds to step S3.
Step S3: Transmission/reception processor 12 transmits web page data to PC 20 and ends the processing.
Step S4: Authentication processor 13b performs the authentication processing.
Step S5: Authentication processor 13b determines whether or not the user is authorized to execute the direct print. If the user is determined to be authorized to execute the direct print, the processing proceeds to step S7. If the user is determined to be unauthorized to execute the direct print, the processing proceeds to step S6.
Step S6: Transmission/reception processor 12 transmits a response of an authentication failure and an authentication failure notification web page to PC 20 and ends the processing.
Step S7: Transmission/reception processor 12 transmits print permission (permission to start print data transmission) to PC 20.
Step S8: Transmission/reception processor 12 checks for receiving any print data from PC 20. If the print data is received, the processing proceeds to step S9. If no print data is received, transmission/reception processor 12 repeats checking until receiving any print data.
Step S9: Transmission/reception processor 12 receives print data.
Step S10: Print data converter 13c converts the received print data into a printable format.
Step S11: Print controller 16 prints the converted data onto a recording medium.
Step S12: Charge log accumulation processor 13d updates the number of pages printed in color, the number of pages printed in monochrome and the total amount accumulated, which are stored in charge log storage unit 14c in accordance with the result of the printing, and ends the processing.

Next, a description is given of a subroutine of the authentication processing in step S4 in FIG. 11.

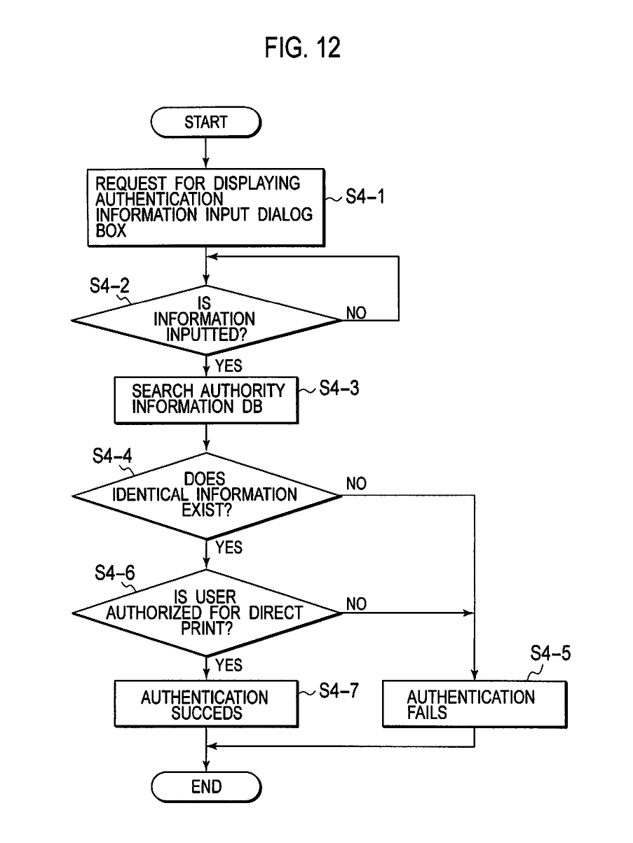

FIG. 12 is a flowchart showing the subroutine of the authentication processing in the first embodiment.

First, printer 10 requests PC 20 to display the authentication information input dialog and waits for the user to input authentication information into the dialog.

Subsequently, when the user inputs authentication information into the dialog, authentication processor 13b searches authority information database 14b and checks for the existence of information that is identical with the input authentication information in authority information database 14b.

Then, when the information that is identical with the input authentication information does not exist in authority information database 14b, authentication processor 13b determines that the authentication fails and ends the processing.

In addition, when the information that is identical with the inputted authentication information exists in authority information database 14b, authentication processor 13b checks whether or not the information that is identical with the inputted authentication information is authorized to execute the direct print, in short, whether or not the user is authorized for the direct print.

When the user is not authorized for the direct print, authentication processor 13b determines that the authentication fails, and ends the processing. When the user is authorized for the direct print, authentication processor 13b determines that the authentication is successful, and ends the processing.

Next, a description is given of a flowchart of FIG. 11.
Step S4-1: Printer 10 requests PC 20 to display the authentication information input dialog.
Step S4-2: Printer 10 waits for the user to input authentication information into the dialog. When the user inputs the authentication information into the dialog, the processing proceeds to step S4-3
Step S4-3: Authentication processor 13b searches authority information database 14b.
Step S4-4: Authentication processor 13b checks for the existence of information that is identical with the inputted authentication information in authority information database 14b. If the information exists, the processing proceeds to step S4-6. If the information does not exist, the processing proceeds to step S4-5.
Step S4-5: Authentication processor 13b determines that the authentication fails and ends the processing.
Step S4-6: Authentication processor 13b checks whether or not the information that is identical with the inputted authentication information shows that the user is authorized to execute the direct print. If the user is authorized for the direct print, the processing proceeds to step S4-7. If the user is not authorized for the direct print, the processing proceeds to step S4-5.
Step S4-7: Authentication processor 13b determines that the authentication is successful, and ends the processing.

As described, in this embodiment, upon receipt of a direct print request from PC 20, printer 10 requests PC 20 to input authentication information and compares the inputted authentication information with information registered in authority information database 14b. When determining the user requesting a direct print is authorized for the direct print, printer 10 receives print data from PC 20 and makes a print. Thus, even if PC 20 is an host apparatus which does not have a printer driver installed therein, printing limitation and charge processing for each user can be performed as in the case of printing performed using a printer driver.

In addition, without installing a printer driver or setting details for printing, the printing limitation and charge processing for each user can be performed by only providing each user with a user name, a password and web connection destination information such as an IP address of the printer.

Next, a second embodiment is described. Note that, the same reference numerals are given to denote elements having the same structure as those of the first embodiment, and the descriptions thereof are omitted. In addition, the description of an effect or operation which is the same as that of the first embodiment is omitted.

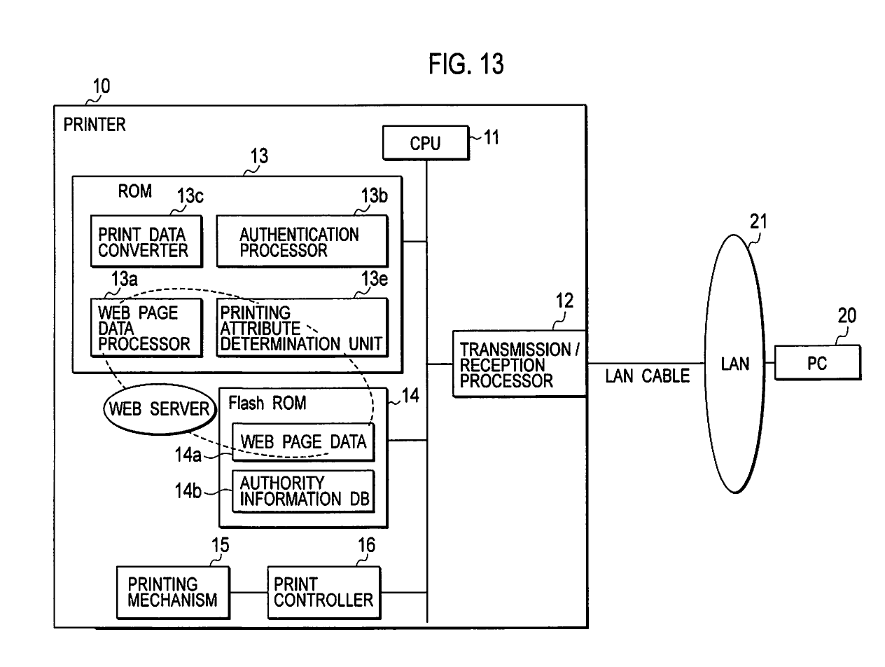

FIG. 13 is a diagram showing a system of a printer in the second embodiment.

In this embodiment, when a user executes a direct print by operating PC 20, the user is allowed to specify printing attributes such as the number of copies to be printed, chromaticity (a color print or monochrome print), or the number of sides (a single sided print or double sided print). When a printing attribute specified by a user is not permitted, the user is notified of a printing attribute applied to the printing before the printing and asked for a final confirmation.

As shown in FIG. 13, printer 10 in this embodiment includes CPU 11, transmission/reception processor 12, ROM 13, Flash ROM 14, printing mechanism 15 and print controller 16.

ROM 13 includes printing attribute determination unit 13e in addition to web page data processor 13a, authentication processor 13b and print data converter 13c. Printing attribute determination unit 13e determines a printing attribute by comparing a printing attribute requested by a user executing a direct print with permitted printing attributes. Note that, compared to the first embodiment, charge log accumulation processor 13d is omitted.

In addition, Flash ROM 14 includes web page data 14a to be transmitted to PC 20, and authority information database 14b which stores authority information of each user for accessing to printer 10. Note that, compared to the first embodiment, charge log storage unit 14c is omitted.

Note that, printing mechanism 15 is provided with a paper feed mechanism, a printing head and the like and prints data such as print data on a recording medium such as a recording paper. Moreover, print controller 16 controls an operation of printing mechanism 15.

When PC 20 transmits print data to printer 10, transmission/reception processor 12 of printer 10 receives the print data.

CPU 11, web page data processor 13a and web page data 14a accomplish a web server function performed by printer 10 in this embodiment. In other words, CPU 11, web page data processor 13a and web page data 14a function as a web server. In response to a web access request from PC 20, CPU 11 causes web page data processor 13a to operate. Then, web page data processor 13a transmits web page data read from web page data 14a to PC 20 through transmission/reception processor 12. A web page to be displayed by a display of PC 20 on the basis of the web page data functions as a specifying unit for allowing a user to specify a text or an image file as a print target and also as an input unit for allowing a user to input user authentication information. In addition, authentication processor 13b functions as an authentication unit, and printing attribute determination unit 13e functions as a printing attribute restriction unit configured to restrict printing attribute with respect to each user.

FIG. 2 shows an example of authority information registered in authority information database 14b. In the example shown in FIG. 2, authority information database 14b stores authentication information of each user such as a user name and a password, and authority information of each user such as permissions for direct printing, monochrome printing, color printing and etc.

For example, for the user with user name “User3,” the password “Password3” is required information for authentication, and this user is authorized to execute a direct print and to use “color printing,” but not authorized to use “double sided printing.”

In this embodiment, since information registered in authority information database 14b is defined as management information base (MIB) information, the information can be edited by a general simple network management protocol (SNMP) tool or the like. The information is also assumed to be edited from an unillustrated operation panel of printer 10 or a web browser. Note that a known technology is used as editing means for the information registered in authority information database 14b, and therefore a description of the editing means is omitted herein. In this embodiment, the information is previously registered in authority information database 14b.

Note that, the other elements and configurations of this embodiment have the same structure as those of the first embodiment, and thus the descriptions thereof are omitted.

Next, a communication procedure between printer 10 and PC 20 is described.

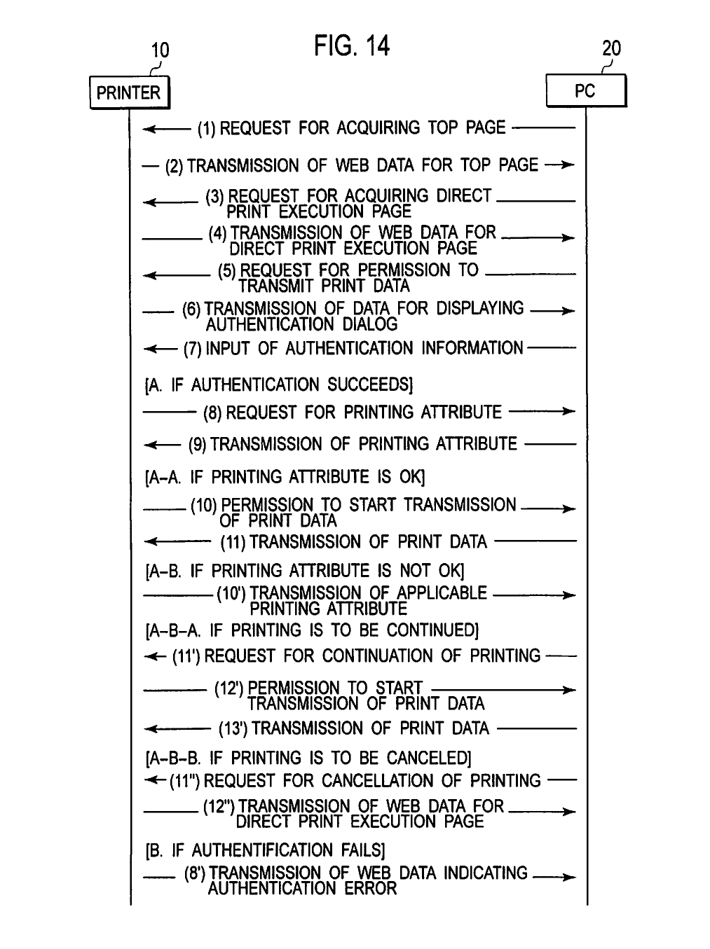

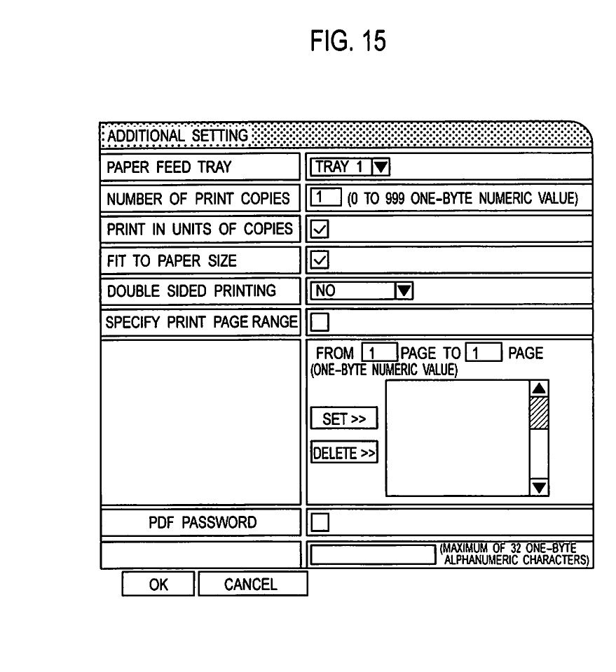

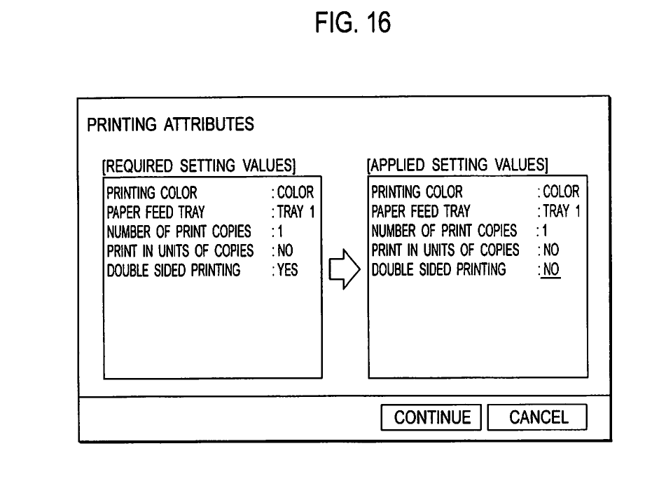

FIG. 14 is a diagram showing the communication procedure between the printer and the PC in the second embodiment; FIG. 15 is a diagram showing an example of a web page for specifying printing attributes in the second embodiment; FIG. 16 is a diagram showing an example of a printing attribute change notification page in the second embodiment.

First, a user operates PC 20 to start a web browser. Upon connecting to an IP address of printer 10 (FIG. 14 (1)), a web page data appropriate to the top page is transmitted from printer 10 to PC 20 (FIG. 14 (2)). Then, the top page as shown in FIG. 5 is displayed on the display of PC 20. In the example illustrated in FIG. 5, “Print” shown at the center left portion of the top page is the link for a direct print execution page.

Next, when a user clicks the link for a direct print execution page on the top page displayed on the display of PC 20 (FIG. 14 (3)), web page data of the direct print execution page is transmitted from printer 10 to PC 20 (FIG. 14 (4)). Then, the direct print execution page as shown in FIG. 6 is displayed on the display of PC 20. In the example illustrated in FIG. 6, the message ““Paper feed tray,” “Number of print copies,” “print page range” and etc. can be set” shown at the center portion of the direct print execution page is the link for a web page for specifying printing attributes.

When the user clicks the link for the web page for specifying printing attributes on the direct print execution page displayed on the display of PC 20, the web page for specifying printing attributes as shown in FIG. 15 is displayed on the display of PC 20. Information input on the web page for specifying printing attributes is printing attributes to be sent from PC 20 to printer 10.

Next, when the user selects a file desired to be printed on the direct print execution page displayed on the display of PC 20 and clicks the “Print” button at a lower part of the page (FIG. 14 (5)), data required for displaying an authentication information input dialog is transmitted from printer 10 to PC 20 (FIG. 14 (6)). Then, the authentication information input dialog as shown in FIG. 7 is displayed on the display of PC 20.

Subsequently, when the user inputs the user name and the password on the authentication information input dialog displayed on the display of PC 20 and clicks the “OK” button at the lower portion of the dialog, the input authentication information is transmitted from PC 20 to printer 10 (FIG. 14 (7)). The authentication information is received by transmission/reception processor 12 of printer 10, and then compared by authentication processor 13b with the authority information stored in authority information database 14b.

When the input authentication information is “Not registered” in authority information database 14b, or is “Registered” but “Unauthorized for direct print,” printer 10 transmits to PC 20 a response indicating an authentication failure, and web page data for informing the user of the authentication failure (FIG. 14 (8′)). Then, a web page as shown in FIG. 8 is displayed on the display of PC 20, which indicates that a direct print is not executed due to an authentication failure.

In the example of authority information shown in FIG. 2, the following cases fall under “Not registered.” The cases are where any name other than “User1,” “User2,” “User3,” “User4” and “User5” is specified as a user name, or where a password not corresponding to a user name is specified, such as a case where “User2” is specified as the user name, but a password other than “Password2” is specified. In addition, when the user name, “User1” not authorized to execute a direct print, and the password, “Password1” are specified, the user falls under “Unauthorized for direct print” even though the user is “Registered.”

When the input authentication information is “Authorized for direct print,” a request for printing attributes is transmitted from printer 10 to PC20 (FIG. 14 (8)). In response to this, PC 20 transmits printing attributes to printer 10 (FIG. 14 (9)).

Then printing attributes determination unit 13e determines whether or not the specified printing attributes is permitted to the user. When the specified printing attributes includes any printing attribute that is not permitted to the user, a printing attribute change notification page as shown in FIG. 16 is transmitted from printer 10 to PC 20, which is a web page for notifying the user that the specified printing attribute is changed to a permitted printing attribute to be used for the printing (FIG. 14 (10′)).

In the example of authority information shown in FIG. 2, in the case where “User3” as a user name and “Password3” as a password are input and “Double sided printing” as a printing attribute is specified, User3 is authorized for direct printing but not permitted to use “Double sided printing,” so that the printing attribute change notification page as shown in FIG. 16 is transmitted from printer 10 to PC 20. In this case, the applied printing attribute will be “Single sided printing.” In another example, in the case where “User2” as a user name and “Password2” as a password are input and “color printing” as a printing attribute is specified, User2 is authorized for direct printing but not permitted to use “Color printing” so that the printing attribute change notification page is transmitted from printer 10 to PC 20. In this case, the applied printing attribute will be “Monochrome printing.”

Then, when the user selects “Cancel” button on the printing attribute change notification page (FIG. 14 (11″)), web page data of the direct print execution page is transmitted from printer 10 to PC 20 (FIG. 14 (12″)).

On the other hand, when the user selects “Continue” button on the printing attribute change notification page (FIG. 14 (11′)) or the specified printing attributes are all permitted, a response informing permission to start print data transmission is transmitted from printer 10 to PC 20 (FIG. 14 (12′) and (10)). In response to this permission, PC 20 transmits print data (the printing target file) to printer 10 (FIG. 14 (13′) and (11)).

Then, print data converter 13c of printer 10 converts the received file into a printable format and print controller 16 controls controlling printing mechanism 15 to execute printing. Note that, a known technique is used for the method of converting the file, and therefore a description thereof is omitted herein.

Next, an operation of printer 10 of the aforementioned configuration is described.

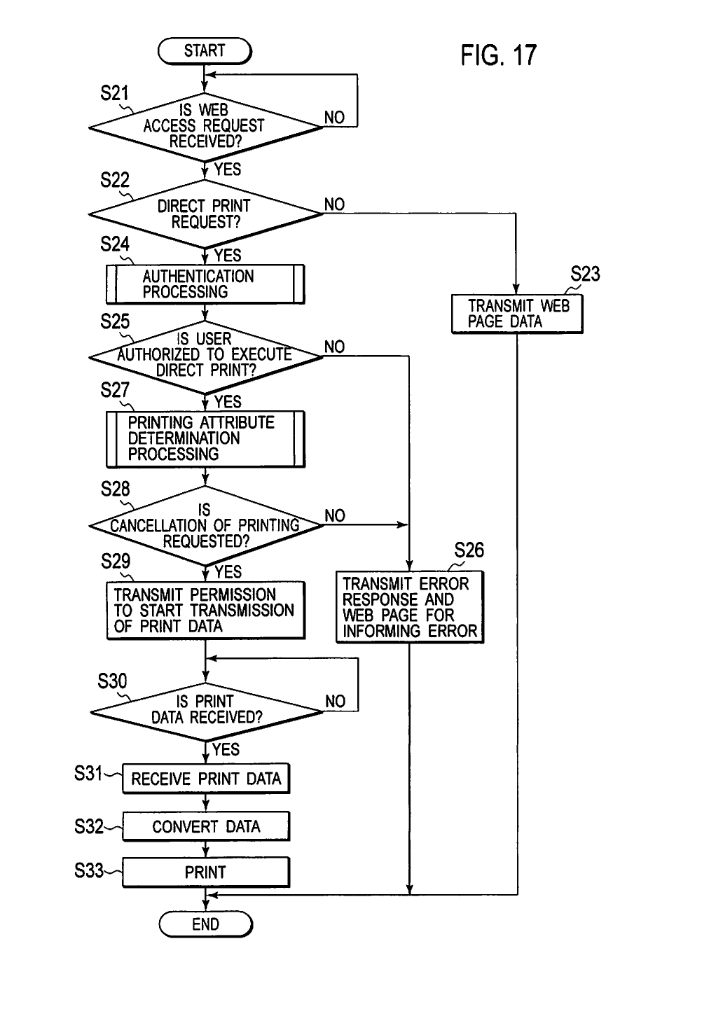

FIG. 17 is a flowchart showing an operation of printer 10 in the second embodiment.

First, transmission/reception processor 12 of printer 10 checks for any new web access request from PC 20. If no request is received, transmission/reception processor 12 repeats checking until receiving a request.

When transmission/reception processor 12 receives a web access request, web page data processor 13a analyzes the received web access request and determines if the web access request is a request for a direct print or a request for web page data. If the request is for web page data, transmission/reception processor 12 transmits web page data read from web page data 14a to PC 20 and ends the processing.

In addition, if the request is for a direct print, authentication processor 13b performs authentication processing. Then, authentication processor 13b determines whether or not the user is authorized for the direct print on the basis of the result of the authentication processing. When authentication processor 13b determines that the user is not authorized for the direct print, transmission/reception processor 12 transmits a response of an authentication failure and an authentication failure notification web page read from web page data 14a to PC 12 and ends the processing.

On the other hand, when authentication processor 13b determines that the user is authorized for the direct print, printing attribute determination unit 13e executes printing attribute determination processing. When printing attribute determination unit 13e determines that printing attributes selected by the user are permitted to the user, transmission/reception processor 12 transmits print permission (permission to start print data transmission) to PC 20.

When printing attribute determination unit 13e determines that printing attributes which the user selects are not permitted to the user, printing attribute determination unit 13e changes printing attribute to be used for printing from the selected printing attributes to the permitted printing attributes, and transmission/reception processor 12 transmits to PC 20 Web page data for letting the user decide whether or not to cancel the printing with the changed printing attributes. When the user requests to cancel the printing, that is, when printer 10 receives from PC 20 a request to cancel the printing, transmission/reception processor 12 transmits an authentication failure response and an authentication failure notification web page read from web page data 14a to PC 12 and ends the processing.

When the user requests not to cancel the printing, that is, the printer 10 receives from PC 20 a request to continue printing, transmission/reception processor 12 transmits to PC 20 print permission (permission to start print data transmission). Subsequently, transmission/reception processor 12 checks for receiving any print data from PC 20. If no print data is received, transmission/reception processor 12 repeats checking until receiving any print data.

When transmission/reception processor 12 receives print data, print data converter 13c converts the received print data into a printable format. Subsequently, print controller 16 controls printing mechanism 15 to print the converted data onto a recording medium.

Next, a description is given of a flowchart of FIG. 17.
Step S21: Transmission/reception processor 12 checks for receiving any web access request from PC 20. If a web access request is received, the processing proceeds to step S22, and if no web access request is received, transmission/reception processor 12 repeats checking until receiving any web access request.
Step S22: Web page data processor 13a determines if the received web access request is a request for a direct print or for web page data. If the request is for a direct print, the processing proceeds to step S24. If the request is for web page data, the processing proceeds to step S23.
Step S23: Transmission/reception processor 12 transmits web page data to PC 20 and ends the processing.
Step S24: Authentication processor 13b performs the authentication processing.
Step S25: Authentication processor 13b determines whether or not the user is authorized to execute the direct print. If the user is determined to be authorized to execute the direct print, the processing proceeds to step S27. If the user is determined to be unauthorized to execute the direct print, the processing proceeds to step S26.
Step S26: Transmission/reception processor 12 transmits an authentication failure response and an authentication failure notification web page to PC 20 and ends the processing.
Step S27: Printing attribute determination unit 13e executes printing attribute determination processing.
Step S28: Transmission/reception processor 12 checks for receiving a request to cancel the printing. If the request is not a request to cancel the printing, that is, the request is a request to continue the printing, the processing proceeds to step S29. If the request is a request to cancel the printing, the processing proceeds to step S26.
Step S29: Transmission/reception processor 12 transmits permission to print (permission to start print data transmission) to PC 20.
Step S30: Transmission/reception processor 12 checks for receiving any print data from PC 20. If the print data is received, the processing proceeds to step S31. If no print data is received, transmission/reception processor 12 repeats checking until receiving any print data.
Step S31: Transmission/reception processor 12 receives print data.
Step S32: Print data converter 13c converts the received print data into a printable format.
Step S33: Print controller 16 prints the converted data onto a recording medium, and ends the processing.

Next, a description is given of a subroutine of the authentication processing in step S24 in FIG. 17.

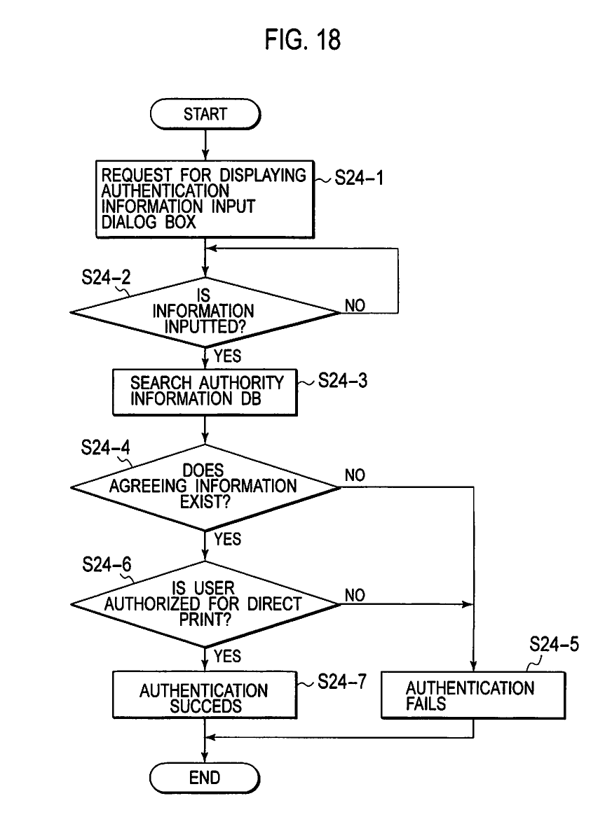

FIG. 18 is a flowchart showing the subroutine of the authentication processing in the second embodiment.

First, printer 10 requests PC 20 to display the authentication information input dialog and waits for the user to input authentication information into the dialog.

Subsequently, when the user inputs authentication information into the dialog, authentication processor 13b searches authority information database 14b and checks for the existence of information that is identical with the inputted authentication information in authority information database 14b.

When the information that is identical with the input authentication information does not exist in authority information database 14b, authentication processor 13b determines that the authentication fails and ends the processing.

When the information that is identical with the input authentication information exists in authority information database 14b, authentication processor 13b checks whether or not the information that is identical with the input authentication information shows that the user is authorized to execute the direct print, in short, whether or not the user is authorized for the direct print.

When the user is not authorized for the direct print, authentication processor 13b determines that the authentication fails, and ends the processing. When the user is authorized for the direct print, authentication processor 13b determines that the authentication is successful, and ends the processing.

Next, a description is given of a flowchart of FIG. 18.
Step S24-1: Printer 10 requests PC 20 to display the authentication information input dialog.
Step S24-2: Printer 10 waits for the user to input authentication information into the dialog. When the user inputs the authentication information into the dialog, the processing proceeds to step S24-3.
Step S24-3: Authentication processor 13b searches authority information database 14b.
Step S24-4: Authentication processor 13b checks for the existence of information that is identical with the input authentication information in authority information database 14b. If the information exists, the processing proceeds to step S24-6. If the information does not exist, the processing proceeds to step S24-5.
Step S24-5: Authentication processor 13b determines that the authentication fails and ends the processing.
Step S24-6: Authentication processor 13b checks whether or not the information that is identical with the input authentication information shows that the user is authorized to execute the direct print. If the user is authorized for the direct print, the processing proceeds to step S24-7. If the user is not authorized for the direct print, the processing proceeds to step S24-5.
Step S24-7: Authentication processor 13b determines that the authentication is successful, and ends the processing.

Next, a description is given of the subroutine of printing attribute determination processing in step 27 in FIG. 17.

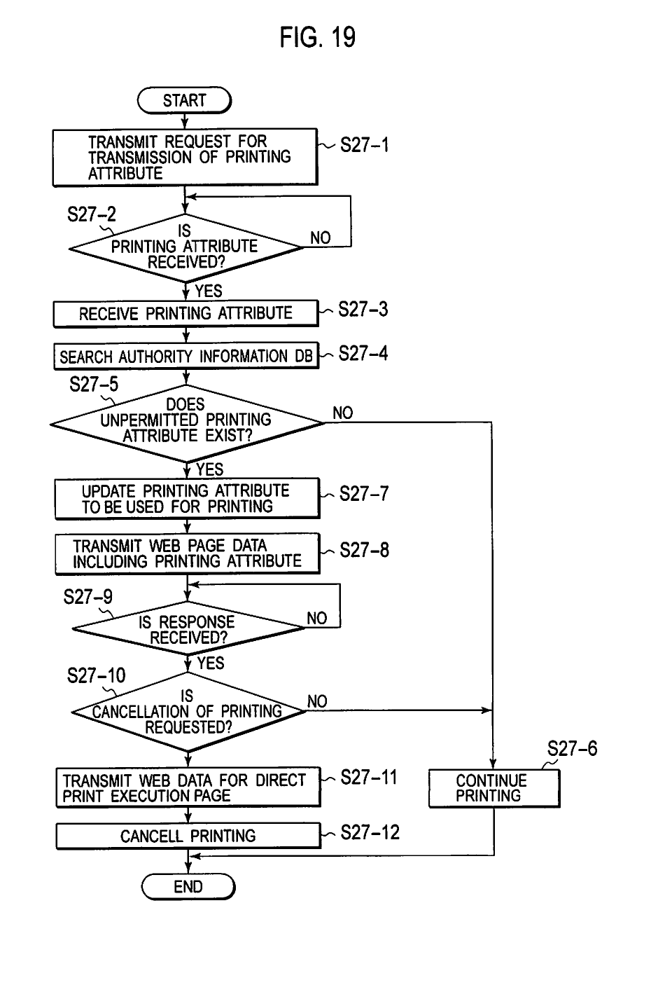

FIG. 19 is a flowchart showing the subroutine of the printing attribute determination processing in the second embodiment.

First, transmission/reception processor 12 transmits a printing attribute transmission request to PC 20 and waits until receiving printing attributes from PC 20. When transmission/reception processor 12 receives the printing attributes, printing attribute determination unit 13e searches authority information database 14b, and checks if the already authenticated user is permitted to use the specified printing attribute. Specifically, printing attribute determination unit 13e checks for the existence of any unpermitted attribute.

When no unpermitted attribute exists, that is, no unpermitted attribute is specified by the user, printing attribute determination unit 13e determines that the printing is continued and ends the processing.

On the other hand, if an unpermitted printing attribute exists, that is, if an unpermitted printing attribute is specified by the user, printing attribute determination unit 13e updates and determines the printing attributes used for the printing. Then, transmission/reception processor 12 transmits web page data to PC 20. In other words, transmission/reception processor 12 transmits web page data including the updated printing attributes to PC 20. Then, transmission/reception processor 12 waits until receiving a response from PC 20.

Subsequently, upon receipt of a response from PC 20, transmission/reception processor 12 checks the received response and determines if the response is a request to cancel the printing. Then, if the response is not a request to cancel the printing, that is, the response is a request to continue the printing, printing attribute determination unit 13e determines that the printing is continued, and ends the processing.

Meanwhile, if the response is a request to cancel the printing, that is, if the response is an instruction to cancel the printing, transmission/reception processor 12 transmits a direct print execution web page to PC 20. Then, printing attribute determination unit 13e determines that the printing is canceled, and ends the processing.

Next, a description is given of a flowchart of FIG. 19.
Step S27-1: Transmission/reception processor 12 transmits a printing attribute transmission request to PC 20.
Step S27-2: Transmission/reception processor 12 waits until receiving printing attributes from PC 20.
Step S27-3: Transmission/reception processor 12 receives the printing attributes.
Step S27-4: Printing attribute determination unit 13e searches authority information database 14b.
Step S27-5: Printing attribute determination unit 13e determines if any unpermitted printing attribute exists. If an unpermitted attribute exists, the processing proceeds to S27-7. If no unpermitted attribute exist, the processing proceeds to S27-6.
Step S27-6: Printing attribute determination unit 13e determines that the printing is continued, and ends the processing.
Step S27-7: Printing attribute determination unit 13e updates the printing attribute used for the printing.
Step S27-8: Transmission/reception processor 12 transmits web page data including the updated printing attribute to PC 20.
Step S27-9: Transmission/reception processor 12 waits until receiving a response from PC 20. Upon receipt of the response, the processing proceeds to step S27-10.
Step S27-10: Transmission/reception processor 12 checks the received response and determines if the response is a request to cancel the printing. If the response is a request to cancel the printing, the processing proceeds to step S27-11. If the response is not a request to cancel the printing, the processing proceeds to step S27-6.
Step S27-11: Transmission/reception processor 12 transmits a direct print execution web page to PC 20.
Step S27-12: Printing attribute determination unit 13e determines that the printing is canceled, and ends the processing.

As described, in this embodiment, upon receipt of a request for direct print from PC 20, printer 10 compares the printing attribute with information registered in authority information database 14b, and determines whether or not the received printing attribute is a permitted printing attribute. When determining that the printing attribute is a permitted printing attribute, printer 10 receives print data from PC 20 and prints the data. Thus, for direct print execution as well, limitation is made on the printing operation in accordance with printing attributes for each user.

In addition, by limiting the use of printer in accordance with printing attributes, it is possible to prevent a print result not desired by the user.

Note that, although the description is given of the case where the image forming apparatus is printer 10 in the first and second embodiments, the invention is not limited to this. The invention is also applicable to a facsimile apparatus, an MFP or the like provided with a printer function.

Moreover, since PC 20, which is an host apparatus, is capable of managing authentication information for a direct print, information on a user who executes printing can be included in an execution log of a direct print.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. An image forming apparatus comprising:
a web server configured to prompt a user to specify a file as a printing target by an external apparatus and to input user information by the external apparatus;
an authentication unit configured to authenticate the user based on the user information input by the external apparatus;
a transmission/reception unit configured to transmit permission or denial to transmit data from the external apparatus based on an authentication result of the authentication unit; and
a print data converter configured to convert the data received from the external apparatus into a printable format.

2. The image forming apparatus of claim 1, further comprising
an authority information storage unit storing information previously registered for each user,
wherein the authentication unit is configured to compare the user information input by the external apparatus with the previously registered information in the authority information storage unit and to determine successful authentication when the input user information matches information in the authority information storage unit.

3. The image forming apparatus of claim 1, further comprising
an authority information storage unit storing information previously registered for each user,
wherein the authentication unit is configured to compare the user information input by the external apparatus with the previously registered information in the authority information storage unit and to determine successful authentication, when the input user information matches information in the authority information storage unit and the user is authorized to execute a direct print.

4. The image forming apparatus of claim 1, further comprising
a printing attribute restriction unit configured to restrict printing attributes for each user.

5. The image forming apparatus of claim 4, wherein
the transmission/reception unit is configured to transmit, before printing, a printing attribute to be used for printing to the external apparatus.

6. The image forming apparatus of claim 1, wherein
the web server is configured to prompt the user to specify, by the external apparatus, a printing attribute to be used for printing,
the image forming apparatus further comprising
a printing attribute restriction unit configured to determine if the specified printing attribute specified by the user by the external apparatus is a permitted printing attribute permitted to the user and, when the specified printing attribute is not a permitted printing attribute, to change the specified printing attribute to the permitted printing attribute to be used for printing.

7. The image forming apparatus of claim 6, wherein
the transmission/reception unit is configured to inform the external apparatus of the change to the permitted printing attribute to prompt the user to select an execution or a cancellation of the printing using the permitted printing attribute.

8. The image forming apparatus of claim 4, wherein
the printing attribute comprises at least chromaticity or the number of sides printed.

9. The image forming apparatus of claim 1, further comprising
a charge unit configured to calculate a printing fee for each user.

10. The image forming apparatus of claim 9, wherein
the charge unit is configure to calculate a printing fee for each user, based on a unit price of each printing attribute previously registered for each user and a number of printed pages.

11. An image forming method of an image forming apparatus, comprising:
when a file is specified as a printing target by an external apparatus and user information is input by the external apparatus, executing authentication of the input information;
transmitting permission or denial to transmit data from the external apparatus in response to a result of the authentication; and
converting the transmitted data from the external apparatus into a printable format for printing the data.

12. The image forming method of claim 11, further comprising
limiting a printing attribute for each user.

13. The image forming method of claim 12, further comprising
transmitting a printing attribute to be used for printing to the external apparatus before printing.

14. The image forming method of claim 11, further comprising
determining if a printing attribute specified by the user by the external apparatus is a permitted printing attribute permitted to the user and, when the specified printing attribute is not the permitted printing attribute, changing the specified printing attribute to the permitted printing attribute to be used for printing.

15. The image forming method of claim 14, further comprising
when the specified printing attribute is changed to the permitted printing attribute to be used for printing, informing the external apparatus of the changed to prompt the user to select an execution or a cancellation of the printing using the permitted printing attribute.

16. The image forming method of claim 12, wherein
the printing attribute comprises at least chromaticity or the number of sides printed.

17. The image forming method of claim 16, further comprising
calculating a printing fee for each user.

18. The image forming apparatus of claim 17, wherein
the printing fee is calculated based on a unit price of each printing attribute previously registered for each user and a number of printed pages.

19. A image forming apparatus comprising:
a web server configured to prompt a user to specify a file as a printing target by an external apparatus and to input user information by the external apparatus;
an authentication unit configured to determine if the user is authorized to execute a direct print based on the input user information input by the external apparatus; and
a print data converter configured to convert data received from the external apparatus into a printable format to execute the direct print authorized by the authentication unit.
